(19) United States
(12) Patent Application Publication
(10) Pub. No.: US 2018/0082323 A1
(43) Pub. Date: Mar. 22, 2018

(54) SELLING ITEM TRANSACTION PROCESSING DEVICE, SELLING ITEM TRANSACTION PROCESSING METHOD AND NON-TRANSITORY COMPUTER READABLE STORAGE MEDIUM

(71) Applicant: YAHOO JAPAN CORPORATION, Tokyo (JP)

(72) Inventor: Shin TSURUTA, Tokyo (JP)

(73) Assignee: YAHOO JAPAN CORPORATION, Tokyo (JP)

(21) Appl. No.: 15/691,124

(22) Filed: Aug. 30, 2017

(30) Foreign Application Priority Data
Sep. 20, 2016 (JP) 2016-183239

(51) Int. Cl. G06Q 30/02; G06Q 30/06

(52) U.S. Cl. CPC G06Q 30/0235; G06Q 30/0643; G06Q 30/0635; G06Q 30/0222

(57) ABSTRACT

A selling item transaction processing device disclosed herein includes a setting reception unit, a transaction price changing unit, a purchase reception unit, and a processing unit. The setting reception unit receives setting of a transaction price of a selling item. The transaction price changing unit gradually lowers the transaction price. The purchase reception unit receives a purchase request on the selling item at the transaction price. The processing unit performs processing in response to the purchase request. The transaction price changing unit dynamically changes a mode of lowering the transaction price.

### CROSS-REFERENCE TO RELATED APPLICATION(S)

The present application claims priority to and incorporates by reference the entire contents of Japanese Patent Application No. 2016-183239 filed in Japan on Sep. 20, 2016.

### BACKGROUND OF THE INVENTION

### 1. Field of the Invention

The present invention relates to a selling item transaction processing device, a selling item transaction processing method, and a non-transitory computer readable storage medium having stored therein a selling item transaction processing program.

### 2. Description of the Related Art

In recent years, selling item transactions between companies, between a company and an individual, and between individuals have been widely conducted via a network along with dramatic popularization of the Internet. For example, a selling item transaction service, configured to perform trading of products in a flea market form via a network, is known, and a user can instantly purchase a selling item at a set transaction price in such a selling item transaction service.

When it is difficult for a seller to set a transaction price that enables a purchase at a price as high as possible, the possibility that a selling item is not purchased increases if the set transaction price is fixed. Therefore, a device, configured to lower a transaction price step by step according to setting by a seller is in order to raise the possibility of purchasing a selling item (for example, refer to JP 2009-277207 A).

However, the transaction price is gradually lowered according to the setting by a user in the above-described conventional service, and thus, there is a risk that it is difficult to appropriately update the transaction price when the user is not used to such setting.

### SUMMARY OF THE INVENTION

It is an object of the present invention to at least partially solve the problems in the conventional technology.

A selling item transaction processing device according to the present application includes a setting reception unit that receives setting of a transaction price of a selling item, a transaction price changing unit that gradually lowers the transaction price, a purchase reception unit that receives a, purchase request on the selling item at the transaction price and a processing unit that performs processing in response to the purchase request, and the transaction price changing unit dynamically changes a mode of lowering the transaction price.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is an explanatory diagram of a selling item transaction processing according to an embodiment;

FIG. 2 is a diagram illustrating a configuration example of a transaction system according to the embodiment;

FIG. 3 is a diagram illustrating an example of a terminal device according to the embodiment;

FIG. 4 is a diagram illustrating a configuration example of a selling item transaction processing device according to the embodiment;

FIG. 5 is a view illustrating an example of a selling item registration screen;

FIG. 6 is a view illustrating an example of a selling information table stored in a selling information storage unit;

FIG. 7 is a view illustrating an example of a selling item list screen displayed on the terminal device;

FIG. 8 is a view illustrating an example of a selling item screen displayed on the terminal device;

FIG. 9 is a view illustrating an example of a change in transaction price;

FIG. 10 is a diagram illustrating an example of a configuration of a transaction price changing unit;

FIG. 11 is a view illustrating an example of a relationship between a change in transaction price and a change in attention degree;

FIG. 12 is a view illustrating another example of the relationship between the change in transaction price and the change in attention degree;

FIG. 13 is a view illustrating an example of a notification screen displayed on the terminal device;

FIG. 14 is a view illustrating an example of the notification screen displayed on the terminal device;

FIG. 15 is a flowchart illustrating flow of information processing in the selling item transaction processing device according to the embodiment; and

FIG. 16 is a diagram illustrating an example of a hardware configuration of a computer that executes a selling item transaction processing program.

### DETAILED DESCRIPTION OF THE PREFERRED EMBODIMENTS

Hereinafter, a mode (hereinafter, referred to as an “embodiment”) for carrying out a selling item transaction processing device, a selling item transaction processing method, and a non-transitory computer readable storage medium having stored therein a selling item transaction processing program according to the present application will be described in detail with reference to the drawings. Incidentally, the selling item transaction processing device, the selling item transaction processing method, and the non-transitory computer readable storage medium having stored therein the selling item transaction processing program according to the present application are not limited to this embodiment.

### 1. Selling Item Transaction Processing

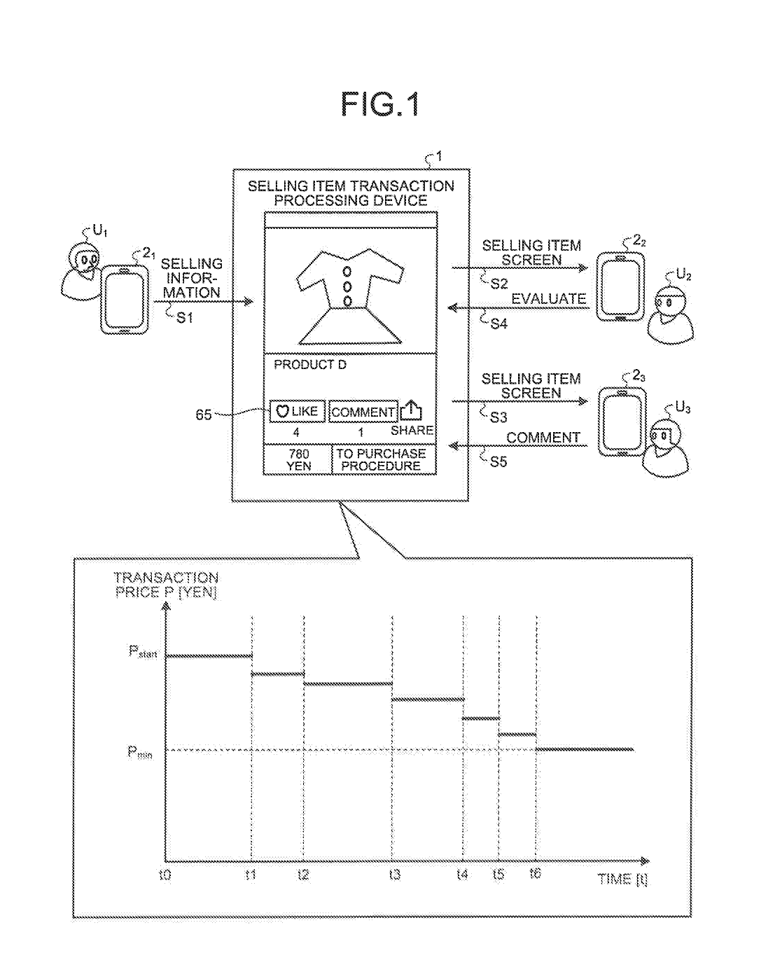

The selling item transaction processing according to the embodiment will be described with reference to FIG. 1. FIG. 1 is an explanatory diagram of the selling item transaction processing according to the embodiment. In the present embodiment, the selling item transaction processing is executed by a selling item transaction processing device 1.

In the example illustrated in FIG. 1, a user U₁ transmits selling information from a terminal device 2₁ to the selling item transaction processing device 1 as a seller (Step S1). For example, the selling information includes information such as a description of a selling item, an image of a selling item, a start price Pₛₜₐᵣₜ, and a minimum price Pₘᵢₙ. The start price Pₛₜₐᵣₜ is a transaction price P of the selling item at the start of display and the minimum price Pₘᵢₙ (<Pₛₜₐᵣₜ) is the minimum price of the transaction price P of the selling item.

When acquiring the selling information from the terminal device 2₁, the selling item transaction processing device 1 starts display processing based on the selling information. After such display processing is performed, the selling item transaction processing device 1 transmits information on a selling item screen 63 in response to a request from terminal devices 2₂ and 2₃ of users U₂ and U₃ who use the selling item transaction processing device 1 (Steps S2 and S3).

The number of favorite registrations for a product D, and the comment number on the product D are included in the selling item screen 63 in addition to the information such as the description of the product D, the image of the product D, and the transaction price P. The users U₂ and U₃ can grasp the information of the product D using the selling item screen 63.

When the user U₂ operates the terminal device 2₂ and operates a registration button 65 to perform a favorite registration with respect to the product D (Step S4), the number of favorite registrations is incremented by one. In the example illustrated in FIG. 1, the number of favorite registrations is “4”.

In addition, when the user U₃ operates the terminal device 2₃ to input a comment on the product D (Step S5), the comment number is incremented by one. In the example illustrated in FIG. 1, the comment number is “1”. In the following description, the terminal devices 2₁, 2₂ and 2₃ will be collectively referred to as a terminal device 2 in some cases.

After setting the transaction price P of the product D to the start price Pₛₜₐᵣₜ, the selling item transaction processing device 1 performs a process of gradually lowering the transaction price P when a state in which the product D is not purchased continues. In the example illustrated in FIG. 1, the transaction price P is gradually lowered from time t1 to t6 after starting display of the product D from time t0 with the transaction price P as the start price Pₛₜₐᵣₜ. When the minimum price Pₘᵢₙ reaches the transaction price P, the selling item transaction processing device 1 ends the process of lowering the transaction price P.

In this manner, the selling item transaction processing device 1 performs the process of gradually lowering the transaction price P when the state in which the selling item is not purchased continues. Thus, it is possible to reduce the possibility that the selling item is not purchased, for example, even when the transaction price P set by the seller deviates from the price at which the user (hereinafter, described as a purchase considerer) who is considering purchase of the selling item intends to purchase.

Further, the selling item transaction processing device 1 dynamically changes the mode of gradually lowering the transaction price P. For example, the selling item transaction processing device 1 can dynamically change the mode of gradually lowering the transaction price P based on a degree of attention with respect to the selling item, an information amount of selling item information (the description and the image of the selling item), a time zone and a day of the week, a transaction price of another selling item which is the same or similar with the selling item.

For example, the selling item transaction processing device 1 can stop the process of lowering the transaction price P or reduce a lowering width ΔP of the transaction price P in a state where the attention degree with respect to the selling item is high. In addition, the selling item transaction processing device 1 can increase a time interval (hereinafter, described as a lowering interval ΔT) to lower the transaction price P in the state where the attention degree with respect to the selling item is high. The attention degree is, for example, the number of favorite registrations with respect to the selling item, the number of comments with respect to the selling item, the number of times of view of the selling item screen 63, and the like.

Since there is a high possibility that the transaction price P is appropriately set for a selling item having a high attention degree, it is possible to prevent the transaction price P from being excessively lowered and to improve a profit that the seller gains by stopping the process of lowering the transaction price P or decreasing the lowering width ΔP of the transaction price P.

On the other hand, when the attention degree with respect to the selling item is low, the selling item transaction processing device 1 can increase the lowering width ΔP of the transaction price P and decrease the lowering interval ΔT.

Since there is a high possibility that the transaction price P is set to be higher for a selling item with a lower attention degree, it is possible to increase the possibility that the selling item is purchased by increasing the lowering width ΔP of the transaction price P or decreasing the lowering interval ΔT of the transaction price P. Thus, for example, it is possible to provide a selling item transaction service targeting a seller who desires to sell a selling item as soon as possible.

In addition, when the information amount of the selling item information is small, the selling item transaction processing device 1 stops the process of lowering the transaction price P, decreases the lowering width ΔP of the transaction price P, or increases the lowering interval ΔT of the transaction price P.

There is a high possibility that there are many materials that an intending purchaser may consider purchasing if the information amount of the selling item information is large. Thus, it is possible to suppress the transaction price P from being excessively lowered by decreasing the lowering width ΔP of the transaction price P or increasing the lowering interval ΔT of the transaction price P.

On the other hand, when the information amount of the selling item information is large, the selling item transaction processing device 1 can increase the lowering width ΔP of the transaction price P and decrease the lowering interval ΔT of the transaction price P. There is a high possibility that there are a few materials that an intending purchaser may consider purchasing if the information amount of the selling item information is small, and thus, there is a high possibility that there are a few purchase considerers.

Thus, it is possible to increase the number of purchase considerers and to increase the possibility of purchase of the selling items by increasing the lowering width ΔP of the transaction price P or decreasing the lowering interval ΔT of the transaction price P. Hereinafter, a configuration of a transaction system including the selling item transaction processing device 1 will be described in detail.

### 2. Transaction System

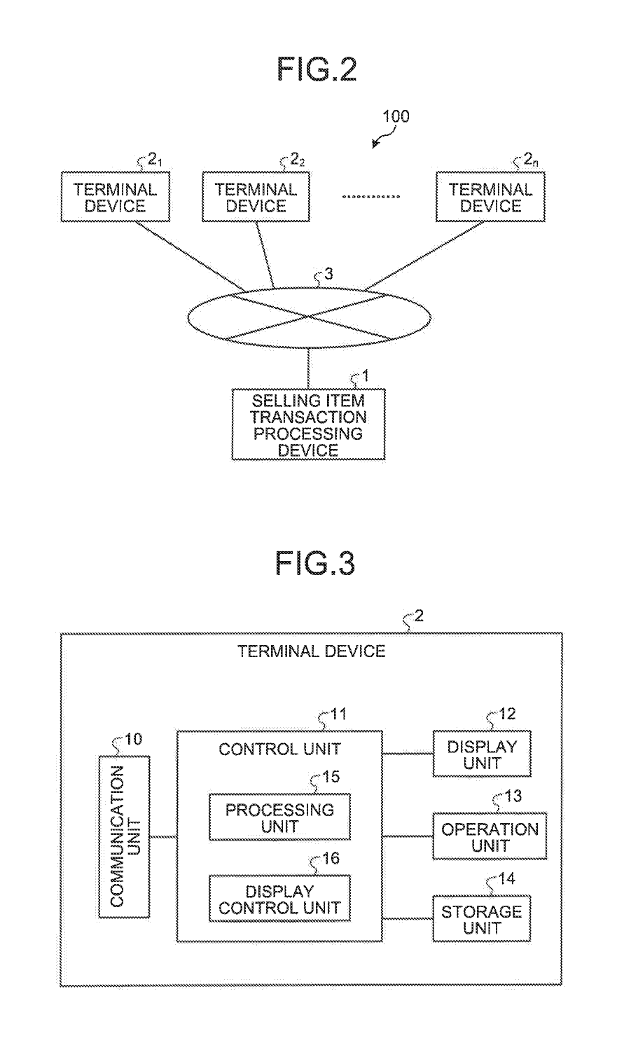

FIG. 2 is a diagram illustrating a configuration example of the transaction system according to the embodiment. As illustrated in FIG. 2, a transaction system 100 according to the embodiment includes the selling item transaction processing device 1 and a plurality of terminal devices 2₁ to 2ₙ (n is an integer of two or more).

The selling item transaction processing device 1 and the plurality of terminal devices 2₁ to 2ₙ (hereinafter, collectively referred to as the terminal devices 2 in some cases) are connected via a network 3 so as to be capable of communicating with each other in a wired or wireless manner. The network 3 is, for example, a local area network (LAN) or a wide area network (WAN) such as the Internet. The terminal devices 2₁ to 2ₙ are operated by users U₁ to Uₙ (hereinafter, collectively referred to as a user U in some cases).

The terminal device 2 is, for example, a smartphone, a tablet terminal, a personal digital assistant (PDA), a personal computer, or the like, and includes a communication unit 10, a control unit 11 (controller), a display unit 12, an operation unit 13, and a storage unit 14. FIG. 3 is a diagram illustrating an example of the terminal device 2.

The control unit 11 includes a microcomputer including a central processing unit (CPU), a read only memory (ROM), a random access memory (RAM), an input/output port, and the like, and various circuits. The display unit 12 is, for example, a liquid crystal display (LCD), and the operation unit 13 is, for example, a keyboard, a touch panel, or the like.

The control unit 22 includes a processing unit 15 and a display control unit 16. Functions of the processing unit 15 and the display control unit 16 are implemented, for example, as the CPU of the control unit 11 reads and executes a program of a selling item transaction processing application stored in the ROM of the control unit 1.

The processing unit 15 detects an operation on the operation unit 13 by the user U, and transmits a request in response to the operation to the selling item transaction processing device 1. In addition, the display control unit 16 can display information on various screens transmitted from the selling item transaction processing device 1 and information in response to an operation input to the operation unit 13 from the user U on the display unit 12 and cause a display screen to perform scroll display in response to a scroll operation using the operation unit 13 of the user U.

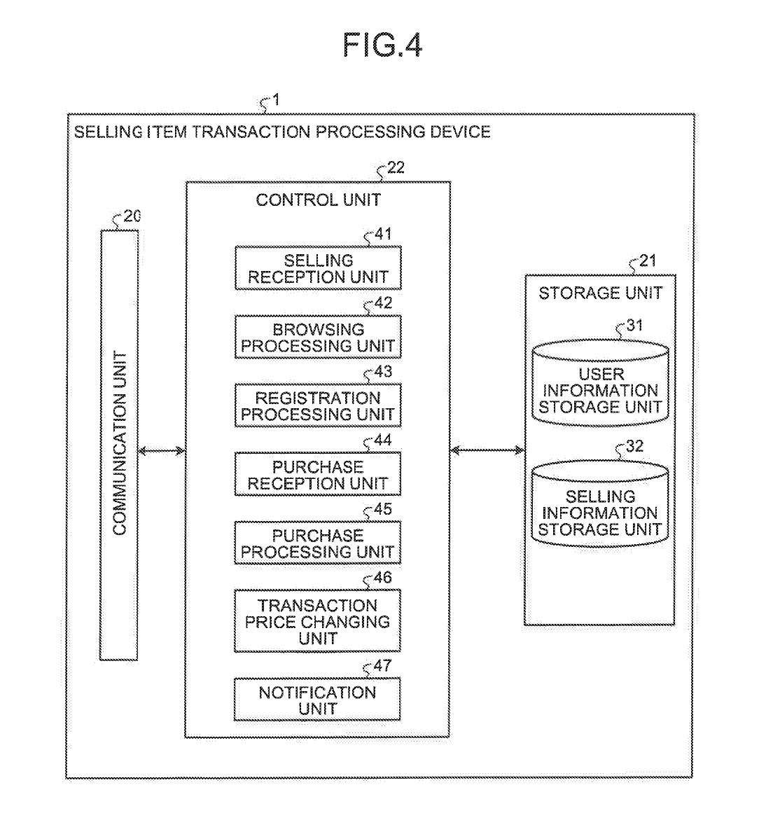

As illustrated in FIG. 4, the selling item transaction processing device 1 includes a communication unit 20, a storage unit 21, and a control unit 22 (controller), and provides the selling item transaction service to the user U of the terminal device 2. FIG. 4 is a diagram illustrating a configuration example of the selling item transaction processing device 1 according to the embodiment. Hereinafter, the communication unit 20, the storage unit 21, and the control unit 22 will be specifically described in this order.

2.1. Communication Unit 20

The communication unit 20 is a communication interface that performs transmission and reception of information with the network 3 and performs connection with the network 3 in a wired or wireless manner. The control unit 22 can transmit and receive various kinds of information to and from the terminal devices 2₁ to 2ₙ via the communication unit 20 and the network 3.

2.2. Storage Unit 21

The storage unit 21 includes a user information storage unit 31 and a selling information storage unit 32.

The user information storage unit 31 and the selling information storage unit 32 are, for example, semiconductor memory elements such as a RAM and a flash memory, or storage devices such as a hard disk drive (HDD) and an optical disk.

The user information storage unit 31 stores a user ID serving as identification information of the user U, an attribute (for example, an age and a sex) of the user U, information on the selling item of the other user U registered by the user U, and evaluation by the other user U, and the like. The selling information storage unit 32 stores the information on the selling item.

2.3. Control Unit 22

The control unit 22 includes, for example, a microcomputer including a CPU, a ROM, a RAM, an input/output port, and the like and various circuits. The control unit 22 includes a selling reception unit 41 (an example of a setting reception unit), a browsing processing unit 42, a registration processing unit 43, a purchase reception unit 44, a purchase processing unit 45 (an example of a processing unit), a transaction price changing unit 46, and a notification unit 47. Functions of the selling reception unit 41, the browsing processing unit 42, the registration processing unit 43, the purchase reception unit 44, the purchase processing unit 45, the transaction price changing unit 46, and the notification unit 47 are implemented, for example, as the CPU of the control unit 22 reads and executes a program stored in the ROM of the control unit 22.

Incidentally, some or all of the selling reception unit 41, the browsing processing unit 42, the registration processing unit 43, the purchase reception unit 44, the purchase processing unit 45, the transaction price changing unit 46, and the notification unit 47 may be configured using hardware such as an application specific integrated circuit (ASIC) and a field programmable gate array (FPGA).

2.3.1. Selling Reception Unit 41

The selling reception unit 41 receives a selling request including the selling information from the terminal device 2 of the seller, for example. The selling information is the information relating to the selling item, and, for example, includes information such as the user ID of the seller, a product name, a product description, the start price Pₛₜₐᵣₜ, the minimum price Pₘᵢₙ, price change setting, a desired period until a successful bid, and a change form.

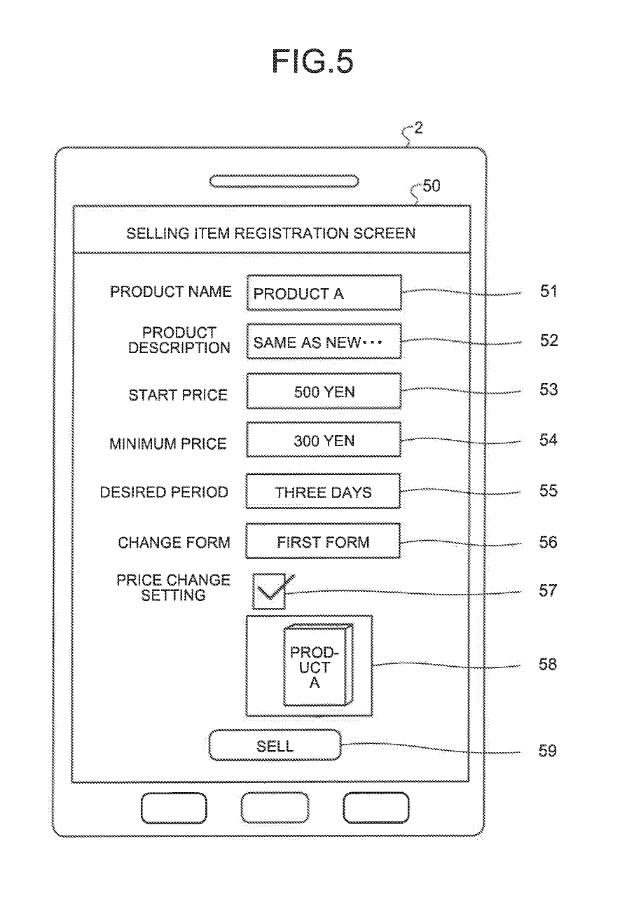

The user U of the terminal device 2, for example, can input the selling information on a selling item registration screen provided from the selling reception unit 41 and transmit the selling request including the input selling item information from the terminal device 2 to the selling item transaction processing device 1. FIG. 5 is a view illustrating an example of a selling item registration screen 50, and information on the selling item registration screen 50 is transmitted from the selling item transaction processing device 1 to the terminal device 2 and is displayed on the display unit 12 by the display control unit 16 of the terminal device 2.

The selling item registration screen 50 illustrated in FIG. 5 includes a product name input frame 51, a product description input frame 52, a start price input frame 53, a minimum price input frame 54, a desired period input frame 55, a change form input frame 56, a price change setting frame 57, and a product image setting frame 58, and the user U of the terminal device 2 can input or set information corresponding to the selling item in the respective frames 51 to 58.

The product name input frame 51 is a frame into which the product name which is the name of the selling item is input, and the product description input frame 52 is a frame into which descriptive notes of the selling item is input. The start price input frame 53 is a frame into which the start price Pₛₜₐᵣₜ which is an initial value of the transaction price P for the selling item is input and the minimum price input frame 54 is a frame into which the minimum price Pₘᵢₙ which is a minimum value of the transaction price P is input.

The desired period input frame 55 is a frame into which the desired period of a period from starts of selling of the selling item to purchase of the selling item, is input. When information on a desired period is input from the user U to the desired period input frame 55, the process of lowering the transaction price P is executed by the transaction price changing unit 46 during the desired period. When a desired period is not input to the desired period input frame 55, the process of lowering the transaction price P is executed by the transaction price changing unit 46 during a reference period (for example, for one month).

The change form input frame 56 is a frame into which a form to gradually lower the transaction price P (hereinafter, described as a change form in some cases) is input. The change form includes, for example, a first form in which the transaction price P is gradually decreased in a linear function manner, a second form in which the transaction price P is gradually decreased in a quadratic curve manner, and a third form in which the change form is dynamically changed in accordance with a condition.

The change forms are not limited to the first form to the third form. For example, the change form may include a form in which the transaction price P is gradually decreased in a linear function manner during the first half of the desired period (or the reference period) and the transaction price P is gradually decreased in a quadratic curve manner during the second half of the desired period (or the reference period).

The price change setting frame 57 is a check box configured to set whether or not to dynamically change the transaction price P. The user U can operate the operation unit 13 to set a check mark in the price change setting frame 57 so as to set a state in which the transaction price P is dynamically changed. In addition, one or more images of the selling item can be set in the product image setting frame 58 by the operation of the operation unit 13 performed by the user U. Incidentally, the setting of the desired period and change form is effective when setting to dynamically change the transaction price P has been made in the price change setting frame 57.

The user U of the terminal device 2 operates the operation unit 13 to set various kinds of information on the product name, product description, the start price Pₛₜₐᵣₜ, the minimum price Pₘᵢₙ, the desired period, the change form, presence or absence of the price change setting, and the image of the selling item in the respective frames 51 to 58 of the selling item registration screen 50. Thereafter, the user U of the terminal device 2 operates the operation unit 13 to select (click) a selling button 59. When the user U of the terminal device 2 selects the selling button 59, the processing unit 15 of the terminal device 2 transmits the selling request including the set information to the selling item transaction processing device 1.

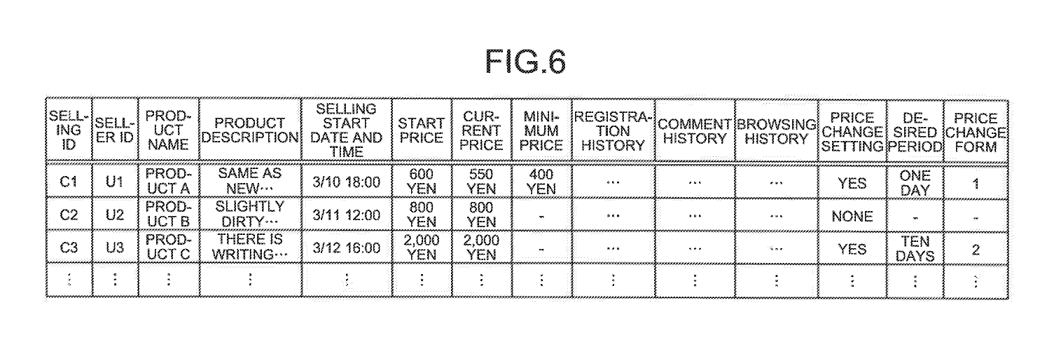

When receiving the selling request including the selling information from the terminal device 2 of the seller, the selling reception unit 41 sets the information included in the selling request in the selling information table stored in the selling information storage unit 32. FIG. 6 is a view illustrating an example of the selling information table stored in the selling information storage unit 32.

The selling information table illustrated in FIG. 6 is information in which “seller ID”, “product name”, “product description”, “start price”, “current price”, “minimum price”, “registration history”, “comment history”, “browsing history”, “selling start date and time”, “price change setting”, “desired period”, and “change form” are associated with each other with respect to “selling ID”. Incidentally, the selling information table also includes information such as the comment on the selling items although not illustrated.

The “selling ID” is identification information allocated for each selling request and the “seller ID” is the user ID of the seller included in the selling information of the selling request. Incidentally, the users U₁ to Uₙ are users of the selling item transaction service provided by the selling item transaction processing device 1, and the user IDs of the users U₁ to Uₙ are U1 to Un (n is an integer of two or more).

In addition, each information on the product name, the product description, the start price, the minimum price, the price change setting, the desired period, and the change form, which are included in the selling information of the selling request, is allocated to the “seller ID”, the “product name”, the “product description”, the “start price”, the “minimum price”, the “price change setting”, the “desired period”, and the “change form”. The “price change setting” is information indicating whether or not to dynamically change the transaction price P.

The “selling start date and time” is a date and time when selling of the selling item is started in the selling item transaction service, and the “current price” is information on the transaction price P at the current point in time. The “registration history” is information such as a date and time when the registration button 65 of the selling item screen (see FIG. 8) is selected (pressed) and the number of times thereof (hereinafter, described as a registration number Ne), and the “comment history” is information on a comment written relating to selling item transaction and the comment number (hereinafter, described as a comment number Nc).

In addition, the “browsing history” is information such as a date and time when the selling item screen (see FIG. 8) to be described later is viewed and the number of times thereof (hereinafter, described to as a browsing number Nv). The “price change setting” is information indicating whether or not to dynamically change the transaction price P, and the “desired period” is a desired period of the period from start of selling of an item to purchase of the selling item. In addition, the “change form” is a change form of the transaction price P.

For example, a user ID “U1” of the seller, a product name “item A”, a product description “same as new”, a selling start date “3/10 18: 00”, a start price “600 yen”, a current price “550 yen”, a minimum price “400 yen”, price change setting “yes”, a desired period “1 day”, a change form “1”, and the like are associated with each other, with respect to a selling ID “C1”, and stored in the selling information storage unit 32 as the selling information. Incidentally, the change form “1” indicates that the first form is set as the change form. The change form is “2” when the second form is set as the change form, and the change form is “3” when the third form is set as the change form.

In addition, a user ID “U2” of the seller, a product name “item B”, a product description “slightly dirty”, a selling start date and time “3/11 12:00”, a start price “800 yen”, a current price “800 yen”, price change setting “none”, and the like are associated with each other, with respect to a selling ID “C2”, and stored in the selling information storage unit 32 as the selling information. Incidentally, since the price change setting “none” is set for a selling item with the selling ID “C2”, the dynamic change processing for the transaction price P is not applied to the selling ID “C2”.

In addition, the minimum price is not set and the price change setting “yes” is set with respect to a selling ID “C3” in the example illustrated in FIG. 6. Thus, the dynamic price change processing for the transaction price P is applied to a selling item with the selling ID “C3”, and a lower limit value of the transaction price P is a fixed value set in advance in the selling item transaction processing device 1. The fixed value is, for example, a value of a predetermined ratio relative to the start price or a predetermined value (for example, 100 yen).

The selling reception unit 41 receives an additional setting request including information that is not set in at the time of performing the selling request after the selling item transaction processing of the selling item in response to the selling request is started, and sets the information included in the additional setting request in the selling information table. Accordingly, it is possible to set the minimum price or the price change setting after starting transaction of the selling item, for example, even when the information on the minimum price or the price change setting is not set at the time of performing the selling request. In addition, even the information set at the time of performing the selling request can be changed (reset) after starting of the transaction of the selling item.

In addition, the selling reception unit 41 can receive a setting cancellation request to cancel setting of one or more pieces of information among the information set at the time of performing the selling request from the terminal device 2 after start of the selling item transaction processing of the selling item in response to the selling request, and delete the information included in the setting cancellation request from the selling information table.

2.3.2. Browsing Processing Unit 42

The browsing processing unit 42 (see FIG. 4) receives a browsing request from the terminal device 2. The browsing request includes, for example, information such as the user ID of the user U of the terminal device 2. When receiving the browsing request from the terminal device 2, the browsing processing unit 42 transmits information on a selling item list screen to the device 2. Accordingly, the information on the selling item is delivered to the terminal device 2. Incidentally, the browsing request is transmitted to the selling item transaction processing device 1 by the processing unit 15 of the terminal device 2, for example, at the time of activation of the selling item transaction processing application in the terminal device 2.

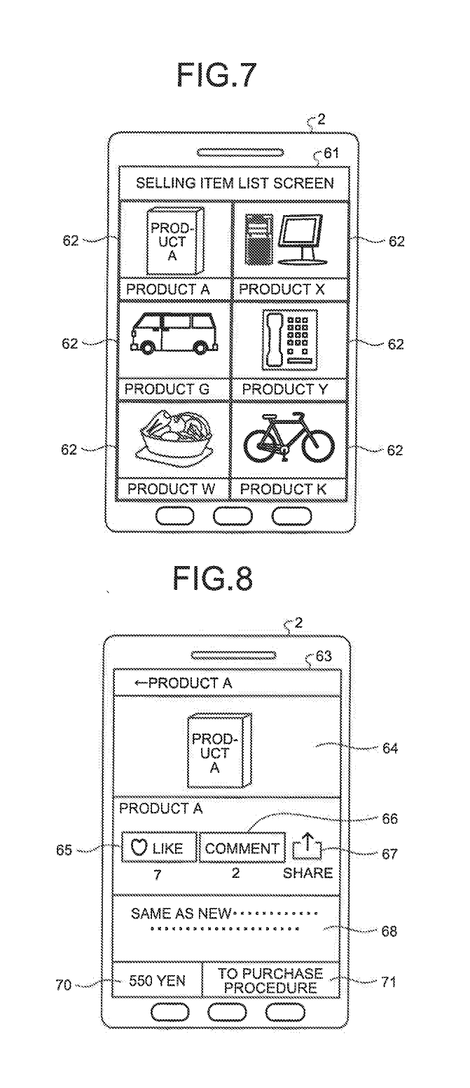

FIG. 7 is a view illustrating an example of a selling item list screen 61 displayed on the terminal device 2. As illustrated in FIG. 7, the information on the selling items is displayed in each of a plurality of display areas 62 on the selling item list screen 61. The selling item list screen 61 is, for example, a vertically long page screen, and the user U of the terminal device 2 can browse information on multiple selling items through a scrolling operation.

The selling item list screen 61 is generated by the browsing processing unit 42 such that a selling item having a newer selling start date and time is displayed in a higher order with a priority, for example. In the example illustrated in FIG. 7, the product A has the newest selling start date and time, a product X is the second newest, and a product G is the third newest. That is, the selling start date and time becomes old in the order of the product A, the product X, the product G, a product Y, a product W, and a product K.

Incidentally, the browsing processing unit 42 can also generate the selling item list screen 61 such that a selling item with a higher sales promotion expense is displayed in a higher order with a priority as will be described later. In this case, the browsing processing unit 42 generates the selling item list screen 61 such that a selling item with a higher sales promotion expense, which is a multiplication value of a sales promotion ratio set by the seller and the transaction price P, is displayed in a higher order with a priority, for example. The information on the sales promotion ratio is designated by the user U, and is set in the selling information table, for example.

The user U of the terminal device 2 selects (clicks) a display area of a desired selling item on the selling item list screen 61 so that an individual browsing request including the selling ID of the selected selling item is transmitted to the selling item transaction processing device 1 from the terminal device 2.

When receiving the individual browsing request transmitted from the terminal device 2, the browsing processing unit 42 updates information on browsing history corresponding to the selling ID included in the individual browsing request. The information on the browsing history includes information such as the user ID of the user U who has browsed the selling item screen 63 to be described later, a browsing date and time, and the number of times of browsing the selling item screen 63 (the browsing number Nv).

In addition, the browsing processing unit 42 transmits the information on the selling item screen 63 to the terminal device 2 when receiving the individual browsing request transmitted from the terminal device 2. FIG. 8 is a view illustrating an example of the selling item screen 63 displayed on the terminal device 2.

As illustrated in FIG. 8, the selling item screen 63 includes a selling item image display area 64, a registration button 65, a comment button 66, a share button 67, a product description area 68, a transaction price display area 70, and a purchase proceeding button 71. Incidentally, the selling item screen 63 includes information on the seller, information on related products, and the like although not illustrated, and the user U of the terminal device 2 can display the information on the seller, the information on the related selling items (other selling items relating to the selling item), and the like in the display area of the terminal device 2 by scrolling the selling item screen 63.

The image of the selling item is displayed in the selling item image display area 64, and the descriptive notes of the selling item is displayed in the product description area 68. The descriptive notes of the selling item include information on the selling item as well as information on a delivery method and charging of a delivery fee, and the like, for example.

The registration button 65 is selected (clicked) by the user U of the terminal device 2 who is considering purchase of the selling item whose image is displayed on the selling item screen 63, for example. When the user U selects the registration button 65, a registration request including the user ID and the selling ID is transmitted from the terminal device 2 to the selling item transaction processing device 1.

The comment button 66 is a button configured to request a comment screen to be described later corresponding to the selling item whose image is displayed on the selling item screen 63. When the user U selects the comment button 66, the processing unit 15 of the terminal device 2 transmits a comment request including the user ID and the selling ID to the selling item transaction processing device 1.

The share button 67 is a button, for example, configured to share the selling item whose image is displayed on the selling item screen 63 with another person using a social network, an e-mail, or the like. When the user U selects the share button 67, the processing unit 15 transmits information (for example, a URL, and the like) on the selling item screen 63 via the social network or the e-mail. In addition, the processing unit 15 transmits information indicating that the share button 67 has been operated together with the selling ID corresponding to the selling item on the selling item screen 63 and the user ID.

Information on the current transaction price P for the selling item is displayed in the transaction price display area 70. For example, a current price “550 yen” is displayed as the transaction price P in the case of the selling item with the selling ID “C1” when the selling information table is in the state illustrated in FIG. 6.

The purchase proceeding button 71 is a button configured to purchase the selling item whose image is displayed on the selling item screen 63. The user U of the terminal device 2 selects (clicks) the purchase proceeding button 71 when deciding to purchase the selling item whose image is displayed on the selling item screen 63. When the purchase proceeding button 71 is selected, the processing unit 15 of the terminal device 2 transmits a purchase request including the user ID and the selling ID to the terminal device 2.

Incidentally the browsing processing unit 42 can display the number of users U who are viewing the selling item screen 63 at the time of generating the information of the selling item screen 63 in real time (hereinafter, described as the number of real-time browsing users) and the browsing number Nv on the selling item screen 63, and can enhance the possibility of purchase by the user U as the number of real-time browsing users is large.

2.3.3. Registration Processing Unit 43

The registration processing unit 43 (see FIG. 4) receives a registration request transmitted from the terminal device 2 and updates the “registration history” of the selling information table corresponding to the selling ID included in the registration request. For example, when there is a registration request with respect to the selling ID “C1” and the selling information table is in the state illustrated in FIG. 6, the registration processing unit 43 updates the user ID included in the registration request and a date and time of the registration request in the selling information table, and further, updates the number of times of registration requests (hereinafter, described to a registration number Ne).

In addition, the registration processing unit 43 stores the user ID and the selling ID in the user information storage unit 31 in association with each other as a registration result when receiving the registration request transmitted from the terminal device 2. The user U of the terminal device 2 can transmit a registration list request including the user ID to the selling item transaction processing device 1 by operating the terminal device 2.

When receiving the registration list request transmitted from the terminal device 2, the registration processing unit 43 acquires the selling ID associated with the user ID based on the user ID included in the registration list request from the registration result in the user information storage unit 31.

Further, the registration processing unit 43 acquires the selling information corresponding to the selling ID included in the registration result from the selling information storage unit 32, and transmits information of a registered selling item list including the acquired selling information to the terminal device 2. Accordingly, the user U of the terminal device 2 can easily know the information on the registered selling item and use the registration button 65 for the favorite registration, for example. Incidentally, the registered selling item list is also called a watch list.

In addition, when receiving the comment request transmitted from the terminal device 2, the registration processing unit 43 acquires information on the comment relating to the selling item corresponding to the selling ID included in the comment request from the selling information table, and transmits the information of the comment screen including the acquired comment to the terminal device 2.

When acquiring the information of the comment screen, the display control unit 16 of the terminal device 2 displays the comment screen (not illustrated) based on the information of the comment screen. The comment input and registered by the seller and the user U other than the seller on the selling item corresponding to the selling ID included in the comment request is displayed in the comment screen.

The user U of the terminal device 2 can input a comment to the comment screen, and the comment thus input is transmitted to the selling item transaction processing device 1 together with the selling ID by the processing unit 15. The registration processing unit 43 sets the comment transmitted from the terminal device 2 and a date and time of the comment to the “comment history” in the selling information table in association with the selling ID, updates the comment number Nc of the “comment history”, and updates the selling information table.

In addition, the registration processing unit 43 can set operation history of the share button 67 to share history (not illustrated) of the selling information table for each selling item. For example, the share history for each selling item includes a date and time when the share button 67 is operated, the user ID of the user U who has operated the share button 67, and the number of times the share button 67 has been operated (hereinafter, referred to as a share number Ns), and the like.

2.3.4. Purchase Reception Unit 44

When receiving the purchase request transmitted from the terminal device 2, the purchase reception unit 44 (see FIG. 4) stores the information on the purchase request in the user information storage unit 31.

2.3.5. Purchase Processing Unit 45

When the purchase request is received by the purchase reception unit 44, the purchase processing unit 45 performs a purchase process at the transaction price P at the time of performing the purchase request. For example, when the selling information table is in the state illustrated in FIG. 6 and there is a purchase request on the selling item with the selling ID “C1”, the purchase processing unit 45 performs the purchase process using the current price “550 yen” as the transaction price P. The purchase process is performed, for example, by settlement using a credit card or by settlement using electronic money.

The purchase processing unit 45 ends a process of selling a selling item on which the purchase process has been performed and excludes the selling item from objects to be displayed on the selling item list screen.

2.3.6. Transaction Price Changing Unit 46

The transaction price changing unit 46 sets the transaction price P for each selling item to the start price Pₛₜₐᵣₜ based on the selling information table stored in the selling information storage unit 32, and then, performs the process of gradually lowering the transaction price P when the selling item is not purchased. The process of gradually lowering the transaction price P is performed based on the information set in the selling information table.

The transaction price changing unit 46 dynamically changes the process of gradually lowering the transaction price P of the selling item whose price change setting is set to “yes” in the selling information table, and does not perform the process of gradually lowering the transaction price P of the selling item whose price change setting is set to “none”.

For example, the transaction price changing unit 46 can dynamically change the mode of gradually lowering the transaction price P based on the attention degree with respect to the selling item whose price change setting is set to “yes”, the information amount of the selling item information (the description and the image of the selling item), the time zone, a transaction price of an object to be transacted which is the same or similar with the selling item, and the like.

FIG. 10 is a diagram illustrating an example of a configuration of the transaction price changing unit 46. As illustrated in FIG. 10, the transaction price changing unit 46 includes an attention degree determination unit 72, an information amount determination unit 73, a market price determination unit 74, an item state determination unit 75, and a price change processing unit 76.

For example, the price change processing unit 76 of the transaction price changing unit 46 can stop the process of lowering the transaction price P or decrease the lowering width ΔP of the transaction price P to be smaller than a reference lowering width ΔPb when the attention degree with respect to the selling item is high. The attention degree with respect to the selling item is determined by the attention degree determination unit 72 based on, for example, the registration number Ne, the comment number Nc, the browsing number Nv, the share number Ns, and the like.

The attention degree determination unit 72 of the transaction price changing unit 46 can determine a value obtained, for example, by performing weighting on each of the registration number Ne, the comment number Nc, the browsing number Nv, and the share number Ns with respect to the selling item and adding the results thereof as the attention degree with respect to the selling item. For example, the attention degree determination unit 72 can calculate an attention degree Da with respect to the selling item based on the following Formula (1). Incidentally, K1 to K4 are coefficients for weighting. Incidentally, each of K1 to K4 has a value of zero or more.

Da=K1×Ne+K2×Nc+K3×Nv+K4×Ns (1)

In addition, the attention degree determination unit 72 can set the number of comments set in the selling information table as the comment number Nc, and also set the number set of comments excluding the comment from the seller from the number of comments set in the selling information table as the comment number Nc.

The attention degree determination unit 72 can calculate the attention degree Da using the above-described Formula (1) based on the registration number Ne, the comment number Nc, the browsing number Nv, and the share number Ns in the latest predetermined period (for example, one hour) for each predetermined period (for example, ten minutes). Incidentally, the browsing number Nv may be the number of real-time browsing, which is the number of users U browsing the selling item screen in real time.

In addition, the attention degree determination unit 72 can calculate the attention degree Da using the above-described Formula (1) based on the registration number Ne, the comment number Nc, the browsing number Nv, and the share number Ns per unit period in a state where there is no change in the transaction price P. The unit period is a period of, for example, one hour, three hours, and the like.

In addition, the attention degree determination unit 72 can calculate the attention degree Da for each predetermined period using the above-described Formula (1) based on the registration number Ne, the comment number Nc, the browsing number Nv, and the share number Ns, which are generated from a timing at which the transaction price P is changed. That is, the attention degree determination unit 72 can calculate the attention degree Da based on the registration number Ne, the comment number Nc, the browsing number Nv, and the share number Ns with respect to a certain transaction price P.

Incidentally the attention degree determination unit 72 can also calculate the attention degree Da with respect to the selling item based on one or more pieces among the registration number Ne, the comment number Nc, the browsing number Nv, and the share number Ns. For example, the attention degree determination unit 72 can determine a value obtained by performing weighting on each of the registration number Ne and the browsing number Nv and adding the results thereof as the attention degree Da with respect to the selling item.

For example, the price change processing unit 76 of the transaction price changing unit 46 performs a process of lowering the transaction price P at a predetermined time interval Tc (an example of a reference lowering interval ΔTb), and updates the current price of the selling information table of the selling information storage unit 32. For example, the price change processing unit 76 of the transaction price changing unit 46 performs the process of lowering the transaction price P of a selling item (for example, the selling item with the selling ID “C1” illustrated in FIG. 6) for which the price change setting “yes” and the price change form “1” are set at the predetermined time interval Tc.

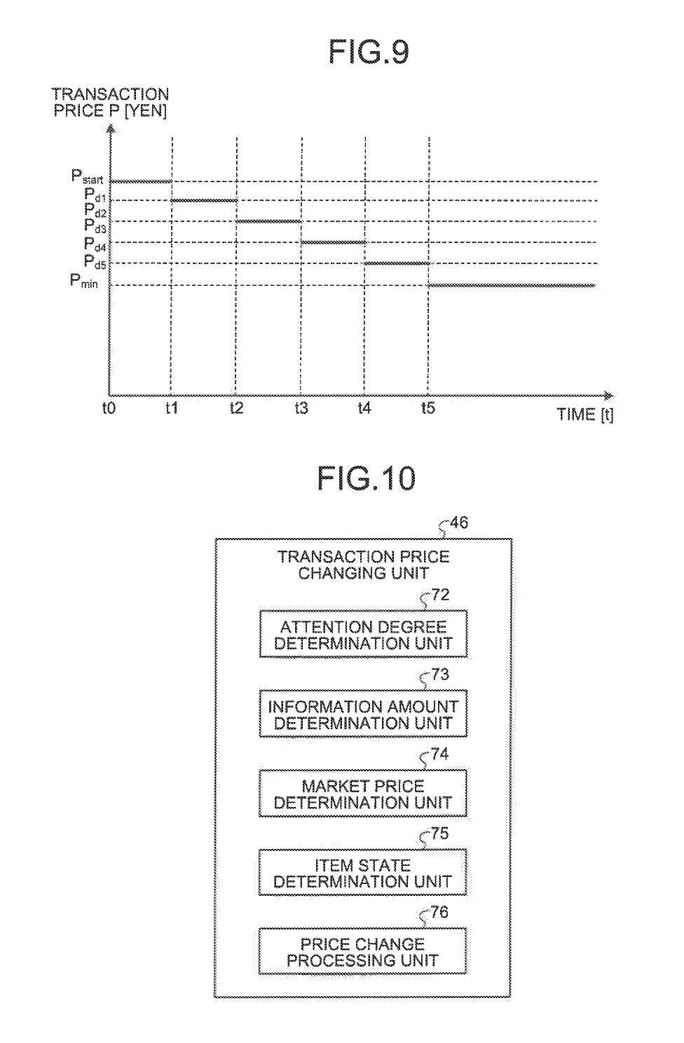

FIG. 9 is a view illustrating an example of a change of the transaction price P. In the example illustrated in FIG. 9, the transaction price P is lowered at the predetermined lowering width ΔP (for example, the reference lowering width ΔPb) at each time t1, t2, t3, t4, and t5 at each of the predetermined time intervals Tc, and the transaction price P becomes the minimum price Pₘᵢₙ at time t5. In this manner, the process of gradually lowering the transaction price P is performed when the selling item is not purchased. Thus, it is possible to reduce the possibility that the selling item is not purchased, for example, even when the transaction price P set by the seller seems to deviate from a desired price of the purchase considerer.

Incidentally, the price change processing unit 76 of the transaction price changing unit 46 can also set a change timing at an unequal interval instead of setting the timing at which the process of lowering the transaction price P (hereinafter, described to as the change timing) at an equal interval. For example, the price change processing unit 76 can gradually decreasing the interval (the reference lowering interval ΔTb) of the change timing with respect to a selling item (for example, the selling item with the selling ID “C3” illustrated in FIG. 6) for which the price change setting “yes” and the change form “2” are set. Accordingly, it is possible to lower the transaction price P in a quadratic curve manner. Thus, it is possible to rapidly lower the transaction price P, for example, in the case of approaching a desired period (for example, one day), and to enhance the possibility of purchase of the selling item.

In addition, the price change processing unit 76 can set the reference lowering width ΔPb according to the change form set by the user U instead of or in addition to setting the lowering interval ΔT according to the change form set by the user U.

For example, when the change form set by the user U is in the first form, the price change processing unit 76 sets the change timing at an equal interval, and further, sets the reference lowering width ΔPb to be constant. Accordingly, it is possible to gradually lower the transaction price P in a linear function manner. In addition, when the change form set by the user U is the second form, the price change processing unit 76 sets the change timing at an equal interval or gradually decreases the intervals, and further, increases the reference lowering width ΔPb. Accordingly, it is possible to lower the transaction price P in a quadratic curve manner.

In addition, when the change form set by the user U is the third form, the price change processing unit 76 selects a change form between the first form and the second form according to a predetermined form condition, and changes at least one of the lowering interval ΔT and the reference lowering width ΔPb with the selected change form. For example, the price change processing unit 76 selects the first form when the attention degree Da is a predetermined value or more, and selects the second form when the attention degree Da is less than the predetermined value.

In addition, the price change processing unit 76 can also select the first form when an information amount Mc of the selling item information is a predetermined amount or more, and select the second form when the attention degree Da is less than the predetermined amount or when the information amount Mc is less than the predetermined amount. Incidentally, the first form and the second form are examples. When the change form set by the user U is the third form, the price change processing unit 76 can also select the other form.

In addition, the price change processing unit 76 of the transaction price changing unit 46 can also decrease the interval of the change timing in a time zone or a day of the week in which the selling item is likely to be purchased. For example, the price change processing unit 76 can decrease the interval of the change timing in a time zone or a day of the week in which there is lots of use of the selling item transaction processing service, and increase the interval of the change timing in a time zone or a day of the week in which there is little use of the selling item transaction processing service.

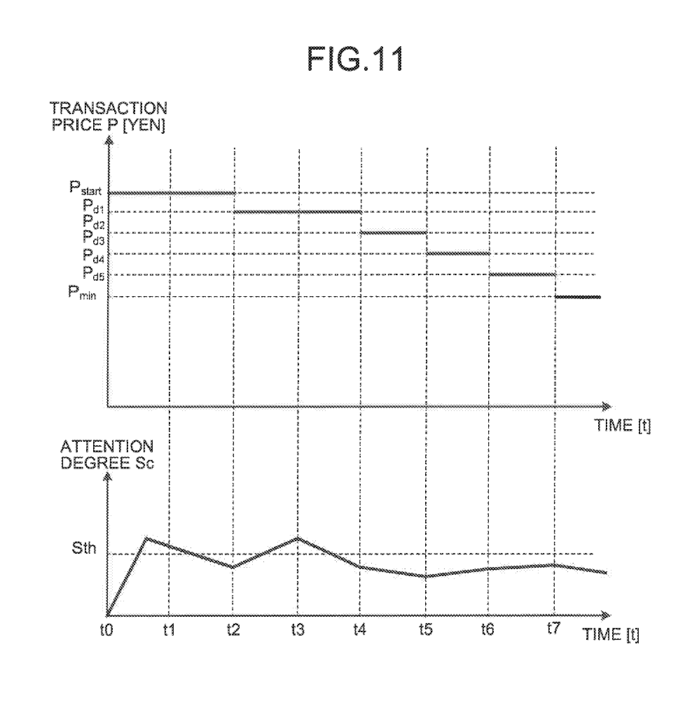

For example, when the attention degree Da with respect the selling item is a predetermined value or more, the price change processing unit 76 can stop the process of lowering the transaction price P or decrease the lowering width ΔP of the transaction price P. FIG. 11 is a view illustrating an example of a relationship between a change of the transaction price P and a change of the attention degree Da.

In the example illustrated in FIG. 11, the price change processing unit 76 stops the process of lowering the transaction price P at time t1 since the attention degree Da is a predetermined value Sth or more, and lowers the transaction price P by the width ΔP at time t2 since the attention degree Da is less than the predetermined value Sth.

Similarly, the price change processing unit 76 stops the process of lowering the transaction price P at time t3 since the attention degree Da is the predetermined value Sth or more, and lowers the transaction price P each by the width ΔP at time t4, t5, t6 and t7 since the attention degree Da is less than the predetermined value Sth.

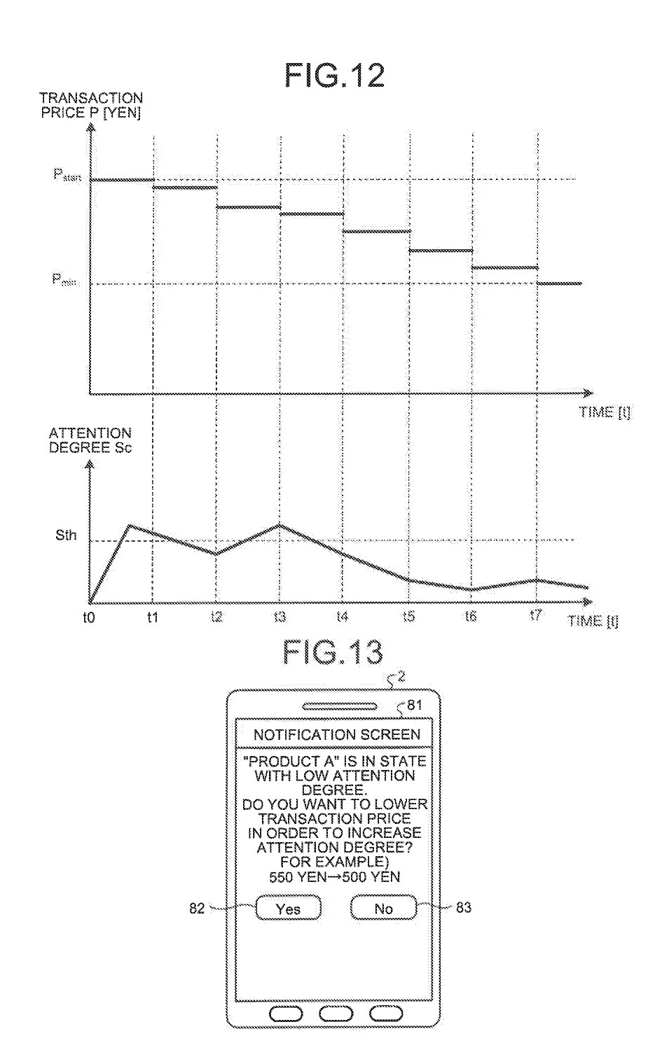

Although the price change processing unit 76 stops the process of lowering the transaction price P when the attention degree Da is the predetermined value Sth or more in the example illustrated in FIG. 11, the price change processing unit 76 can decrease the lowering width ΔP when the attention degree Da is the predetermined value Sth or more. FIG. 12 is a view illustrating another example of the relationship between the change of the transaction price P and the change of the attention degree Da.

In the example illustrated in FIG. 12, the price change processing unit 76 decreases the lowering width ΔP of the transaction price P at time t1 since the attention degree Da is the predetermined value Sth or more, and increases the lowering width ΔP of the transaction price P at time t2 since the attention degree Da is less than the predetermined value Sth.

Similarly, the price change processing unit 76 decreases the lowering width ΔP of the transaction price P at time t3 since the attention degree Da is the predetermined value Sth or more, and increases the lowering width ΔP of the transaction price P at time t4, t5, t6 and t7 since the attention degree Da is less than the predetermined value Sth.

Incidentally, the price change processing unit 76 can also perform the process of lowering the transaction price P at each time t1 to t7 with the lowering width ΔP according to the attention degree Da. For example, the price change processing unit 76 can also obtain the lowering width ΔP by calculation of the following Formula (2). Incidentally, “K5” is a coefficient in Formula (2).

ΔP=K5×Da (2)

In addition, the price change processing unit 76 can change the timing (lowering interval ΔT) at which the transaction price P is lowered according to the attention degree Da. For example, the price change processing unit 76 can lengthen the timing to lower the transaction price P as the attention degree Da is higher. For example, the price change processing unit 76 can calculate an average value of the attention degree Da per predetermined time from setting of the transaction price P to a certain value, and lengthen the timing as the average value is larger.

In addition, the price change processing unit 76 can increase the predetermined time interval Tc or the lowering width ΔP of the transaction price P such that the transaction price P is lowered to the minimum price Pₘᵢₙ during the desired period in order to make the transaction price P of the selling item (for example, the selling item with the selling ID “C1” illustrated in FIG. 6) for which the price change setting “yes” and the desired period are set to be purchased during the desired period (for example, one day) For example, it is assumed that a desired period is “Tx” and a price difference P_{diff} between the start price Pₛₜₐᵣₜ and the minimum price Pₘᵢₙ is “200 yen”. In this case, the price change processing unit 76 can obtain the reference lowering width ΔPb by calculation of the following Formula (3) whenever the predetermined time interval Tc comes.

ΔPb=P_{diff}/(Tx/Tc) (3)

In addition, the price change processing unit 76 can also decrease the lowering width ΔP of the transaction price P to be smaller than the reference lowering width ΔPb when the attention degree Da is the predetermined value Sth or more, and increase the lowering width ΔP of the transaction price P to be larger than the reference lowering width ΔPb when the attention degree Da is less than the predetermined value Sth. Accordingly, it is possible to lower the transaction price P to the minimum price Pₘᵢₙ during the desired period while changing the mode of lowering the transaction price P according to the attention degree Da, thereby enhancing the possibility of purchase.

Incidentally, the price change processing unit 76 can set the lowering width ΔP of the transaction price P as the reference lowering width ΔPb, increase the timing to lower the transaction price P as the attention degree Da is higher and decrease the timing to lower the transaction price P as the attention degree Da is lower. With this configuration, it is also possible to enhance the possibility of purchase. In addition, the price change processing unit 76 can also change the lowering width ΔP of the transaction price P and the timing to lower the transaction price P according to the attention degree Da.

In this manner, the price change processing unit 76 can dynamically change the mode of gradually lowering the transaction price P according to the attention degree Da. Since there is a high possibility that the transaction price P is appropriately set with respect to a selling item with the high attention degree Da, it is possible to prevent the transaction price P from being excessively lowered and to improve a profit that the seller gains by stopping the process of lowering the transaction price P or decreasing the lowering width ΔP of the transaction price P.

On the other hand, since there is a high possibility that the transaction price P is set to be high with respect to the selling item with the low attention degree Da, it is possible to enhance the possibility of purchase of the selling item by increasing the lowering width ΔP of the transaction price P or decreasing the lowering interval ΔT of the transaction price P.

In addition, the price change processing unit 76 can dynamically change the mode of gradually lowering the transaction price P based on the information amount Mc of the selling item information (the description and the image of the selling item). For example, the information amount determination unit 73 can calculate the information amount Mc of the selling item information determined by the information amount determination unit 73 by calculation of the following Formula (4). Incidentally, “K6” and “K7” are coefficients, “Mt” is a length of the descriptive notes of the selling item (for example, the number of characters of text), and “Mp” is the number of images of the selling item in Formula (4). Incidentally, K6 and K7 are values of zero or more.

Mc=K6×Mt+K7×Mp (4)

Similar to the case of the attention degree Da, the price change processing unit 76 can stop the process of lowering the transaction price P based on the information amount Mc, and further, can decrease the lowering width ΔP of the transaction price P or increase the lowering interval ΔT of the transaction price P as the information amount Mc is higher. Incidentally, the price change processing unit 76 can also calculate the information amount Mc of the selling item information based on any one between the length of the descriptive notes of the selling item or the image of the selling item.

In addition, similar to the case of the attention degree Da, the price change processing unit 76 can dynamically change the mode of gradually lowering the transaction price P based on transaction prices of a plurality of other selling items (hereinafter, described as related selling items) having the same type or similar type with the selling item. For example, the price change processing unit 76 can increase the lowering width ΔP of the transaction price P of the selling item as the transaction price of the selling item is higher than an average transaction price or an average purchase price of the related selling items.

In addition, the price change processing unit 76 can reduce the lowering width ΔP of the transaction price P of the selling item as the transaction price of the selling item is lower than the average transaction price or the average purchase price of the related selling items. Incidentally, the “average transaction price” is, for example, an average value of the transaction prices P (current price) at the current point in time of the plurality of related selling items that are being sold at the current point in time, and the “average purchase price” is an average value of the transaction prices P (purchase prices) at the time of purchase of the plurality of related selling items that have been purchased.

Incidentally, the transaction price changing unit 46 can determine the related selling item based on, for example, commonality in the descriptive notes and the images of the selling item. For example, the transaction price changing unit 46 can determine the related selling item by a combination of a result of text mining with respect to the descriptive notes of the selling item and a result of similar image search with respect to the image of the selling item.

In addition, the price change processing unit 76 can dynamically change the mode of gradually lowering the transaction price P based on the market price of the selling item. For example, the price change processing unit 76 can also increase the lowering width ΔP of the transaction price P of the selling item as the transaction price of the selling item is higher than the market price. Incidentally the market price of the selling item is a market price of a product which is the same as the selling item (hereinafter, described as the same product), but may be obtained by considering a market price of a product which is similar to the selling item.

The market price of the selling item is determined by the market price determination unit 74. For example, the market price determination unit 74 can determine an average transaction price or an average purchase price of the same product as the market price of the selling item based on the selling information table. The average transaction price of the same product is an average value of transaction prices of the related selling items at the current point in time and the average purchase price of the same product is an average value of the transaction prices P when the same products are purchased. Incidentally, the market price determination unit 74 can also acquire the market price of the selling item from an external server.

In addition, the price change processing unit 76 can gradually lower the transaction price P of the selling item in a transaction price range higher than the market price of the same item, for example, when the selling item satisfies a predetermined condition (for example, a condition with respect to the attention degree Da) and the transaction price P of the selling item is higher than the market price of the same product. In this case, the price change processing unit 76 can gently decrease the transaction price P by setting the lowering width ΔP of the transaction price P to be smaller than the reference lowering width ΔPb or by setting the lowering interval ΔT to be smaller than the reference lowering interval ΔTb.

Accordingly, it is possible to enhance the possibility of purchase at the appropriate transaction price P. Incidentally, the above-described “predetermined condition” is a condition that the information amount Mc of the selling item information is a set amount or more, a condition that the attention degree Da is a set threshold value or more, or a condition that the selling item is a product with a high probability of establishing a transaction, in the case where the possibility of purchase of the selling item is high.

In addition, the price change processing unit 76 can dynamically change the mode of gradually lowering the transaction price P based on a state of the selling item. For example, the price change processing unit 76 can gently lower the transaction price P by decreasing the lowering width ΔP of the transaction price P to be smaller than the reference lowering width ΔPb or decreasing the lowering interval ΔT to be smaller than the reference lowering interval ΔTb as the state of the selling item is better.

The state of the selling item is determined by the item state determination unit 75. For example, the item state determination unit 75 collects information on an image of a new product as the same product (hereinafter, referred to as a new item image) from the external server. The item state determination unit 75 compares the new item image with the image of the selling item (hereinafter, referred to as a selling item image) and determines the state of the selling item based on a difference between the new item image and the selling item image. Incidentally, the selling item image is acquired from the selling information table by the item state determination unit 75.

For example, it is possible to determine that the state of the selling item is better as the difference between the selling item image and the new item image is smaller, and to determine that the state of the selling item is worse as the difference between the selling item image and the new item image is larger. For example, the item state determination unit 75 can determine a scratch, missing, a flaw (crack) or the like on a surface of the selling item or color fading of the selling item, and the like based on the difference between the selling item image and the new item image, and determine the state of the selling item based on results obtained by such determination.

In addition, the item state determination unit 75 can extract information on the amount of information of deteriorating portions from the descriptive notes of the selling item or the comment with respect to the selling item set in the selling information table, and determine the state of the selling item based on the extracted information.

For example, when information such as “a certain handle portion of the selling item image is somewhat darkened” is included in the descriptive notes of the selling item or the comment on the selling item, it is possible to determine the state of the selling item from the information such as “somewhat” indicating the degree, “darkened” indicating the state, and the like. The item state determination unit 75 can determine the state of the selling item based on a model (for example, a machine learning model) to determine the state of the selling item based on a term indicating a portion, in addition to a term indicating a degree and a term indicating a state.

In addition, similar to the case of the attention degree Da, for example, the transaction price changing unit 46 can stop the process of lowering the transaction price P as evaluation by a purchaser with respect to the seller (hereinafter, described as seller evaluation) is higher, and further, can decrease the lowering width ΔP of the transaction price P or increase the lowering interval ΔT of the transaction price P as the seller evaluation is higher. For example, the seller evaluation is information transmitted from the terminal device 2, and for example, is input by an operation of the user to a seller evaluation screen, transmitted to the terminal device 2 of the purchaser after purchase processing of the selling item from the selling item transaction processing device 1, and is transmitted to the selling item transaction processing device 1.

In addition, the transaction price changing unit 46 is not limited to the example in which the mode of gradually lowering the transaction price P is dynamically changed based on any one of the attention degree Da, the information amount Mc, the time zone and the day of the week, the average transaction price and the average purchase price of the related selling items, and the seller evaluation. That is, the transaction price changing unit 46 can dynamically change the mode of gradually lowering the transaction price P by combining two or more of the attention degree Da, the information amount Mc, the time zone and the day of the week, the average transaction price and the average purchase price of the related selling items, and the seller evaluation.

For example, the transaction price changing unit 46 can calculate the result obtained by adding the weighted attention degree Da and information amount Mc or a result obtained by averaging thereof as a change score, and can dynamically change the mode of gradually lowering the transaction price P based on the change score. In this case, the transaction price changing unit 46 can stop the process of lowering the transaction price P, decrease the lowering width ΔP of the transaction price P, or increase the lowering interval ΔT of the transaction price P as the change score is higher.

Incidentally, the transaction price changing unit 46 lowers the transaction price P regardless of the minimum price Pₘᵢₙ when the minimum price Pₘᵢₙ is not set or when the setting of the minimum price Pₘᵢₙ is canceled (deleted) from the selling information table by the seller after selling of the selling item. Accordingly, it is possible to lower the transaction price P to be lower than the minimum price Pₘᵢₙ when the state in which the selling item is not purchased continues.

2.3.7. Notification Unit 47

For example, when a predetermined period has elapsed after the transaction price P becomes the minimum price Pₘᵢₙ, or when a change score is small, the notification unit 47 can notify the terminal device 2 of a message urging cancellation of the minimum price Pₘᵢₙ. Accordingly, the message urging cancellation of the minimum price Pₘᵢₙ is displayed on the display unit 12 of the terminal device 2, and the user U of the terminal device 2 transmits the setting cancellation request to request the cancellation of the minimum price from the terminal device 2, whereby it is possible to increase the possibility of purchase of the selling item.

In addition, the notification unit 47 can propose price change to a seller of a selling item (for example, the selling item with the selling ID “C2” in FIG. 6) for which the price change setting “yes” is not set. FIG. 13 is a view illustrating an example of a notification screen displayed on the terminal device 2 based on the information notified from the notification unit 47 to the terminal device 2.

For example, when the attention degree Da is lower than the predetermined value, the notification unit 47 transmits information on a notification screen 81 to propose setting of the price change (setting to gradually lower the transaction price P) to the terminal device 2 of the user U as the seller as illustrated in FIG. 13. Accordingly, it is possible to notify the proposal of the price change setting by displaying the notification screen 81 including the proposal of the price change setting on the display unit 12 of the terminal device 2 of the user U as the seller. A change content of the transaction price P and a yes button 82 and a no button 83, configured to determine whether or not to accept the proposal are displayed on the notification screen 81 illustrated in FIG. 13.

When the user U of the terminal device 2 operates the yes button 82, a resetting request including information on a transaction price corresponding to the change content of the transaction price P included in the notification screen 81 and a selling ID is transmitted from the terminal device 2 to the selling item transaction processing device 1. The selling reception unit 41 sets the transaction price included in the resetting request in the selling information table. Accordingly, the user U who is a seller of a selling item to which the dynamic change processing with respect to the transaction price P is not applied can easily change the transaction price P of the selling item. Incidentally, for example, when the attention degree Da is higher than a predetermined value, the notification unit 47 can also transmit the information on the notification screen 81 to propose the price change to the terminal device 2.

In addition, for example, when the change form is set to the second form and the attention degree Da is the predetermined value or more, the notification unit 47 transmits the information on the notification screen to propose a change to the first form of the change form to the terminal device 2 of the user U who is the seller. Accordingly, it is possible to cause the display unit 12 of the terminal device 2 of the user U who is the seller to display the notification screen including the proposal for the change of the change form and to notify the proposal of the change of the change form. In this case, the notification unit 47 can display the browsing number Nv (may be the number of real-time browsing) or the registration number Ne on the notification screen, whereby it is possible to give motivation that makes the seller change the change form.

Incidentally, the notification unit 47 can determine the change timing and the lowering width ΔP of the transaction price P based on any one or more of the attention degree Da, the information amount Mc, the time zone and the day of the week, the average transaction price and the average purchase price of the related selling items, and the seller evaluation, which is similar to the transaction price changing unit 46. The notification unit 47 can transmit the information on the notification screen 81 to the terminal device 2 according to the change content of the transaction price P based on the determined lowering width ΔP at the determined change timing of the transaction price P.

Accordingly, it is possible to change the transaction price P with the mode of lowering the transaction price P as illustrated in FIGS. 11 and 12 in accordance with the user operation. Incidentally, the notification unit 47 can also acquire the change timing and the lowering width ΔP of the transaction price P determined by the transaction price changing unit 46 and generate and transmit the information on the notification screen 81.

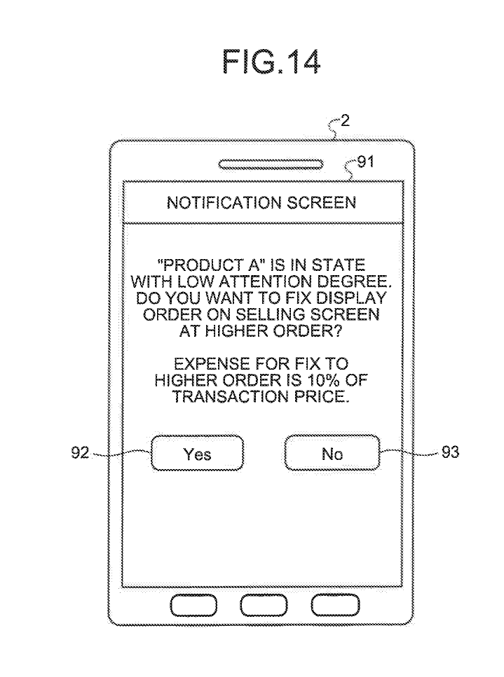

In addition, the notification unit 47 can perform a proposal for payment of the sales promotion expense to raise the attention degree Da to the user U as the seller, together with the process of lowering the transaction price P. For example, the notification unit 47 can transmit the information on a notification screen 91 as illustrated in FIG. 14 to the terminal device 2. FIG. 14 is a view illustrating an example of the notification screen 91 displayed on the terminal device 2.

As illustrated in FIG. 14, a content of the proposal for payment of the sales promotion expense and a yes button 92 and a no button 93, which are configured to decide whether or not to accept the proposal, are displayed. When the user U of the terminal device 2 operates the yes button 92, a resetting request including information of a sales promotion ratio (for example, 10% of the transaction price) included in the notification screen 91 and the selling ID is transmitted from the terminal device 2 to the selling item transaction processing device 1. The selling reception unit 41 sets the sales promotion ratio included in the resetting request in the selling information table.

Accordingly, since the selling item list screen 61 is generated such that the selling item having a higher sales promotion expense is displayed in a higher order with a priority by the browsing processing unit 42, it is possible to increase the attention degree Da with respect to the selling item and to enhance the possibility of purchase. Incidentally, the notification unit 47 can perform the proposal for payment of the sales promotion expense to raise the attention degree Da to the user U as the seller, even when it is difficult to perform the process of lowering the transaction price P.

### 3. Processing Flow of Selling Item Transaction Processing Device 1

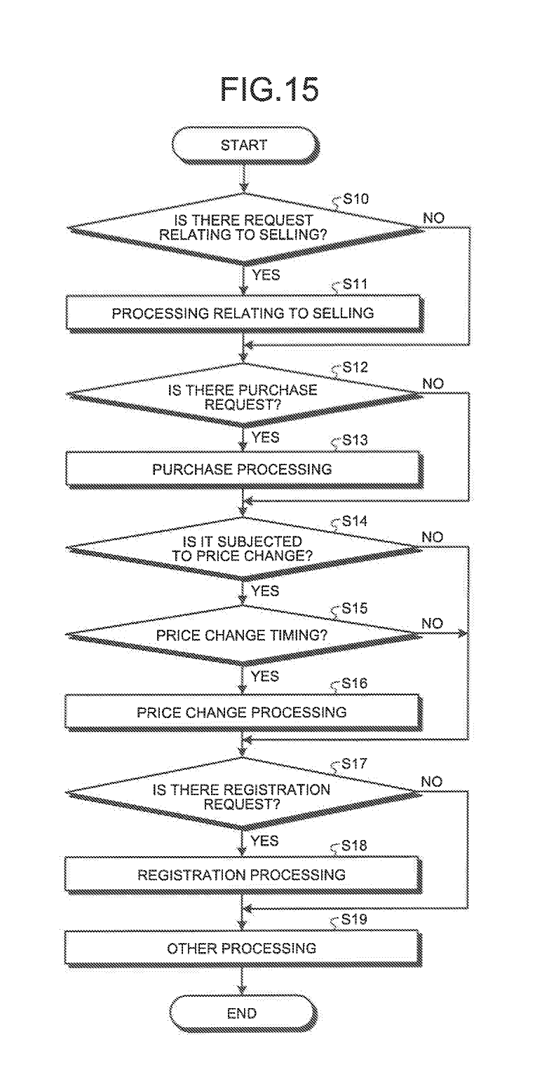

First, an example of a procedure of information processing in the selling item transaction processing device 1 will be described with reference to FIG. 15. FIG. 15 is a flowchart illustrating an example of flow of the information processing in the selling item transaction processing device 1. The information processing is processing performed for each selling item.

As illustrated in FIG. 15, the control unit 22 determines whether or not a request (for example, the selling request, the additional setting request, the setting cancellation request, and the like) relating to selling of the selling item has been received from the terminal device 2 (Step S10). When it is determined that the request relating to selling of the selling item has been received (Step S10; Yes), the control unit 22 performs processing relating to selling of the selling item (Step S11).

For example, the control unit 22 sets information in response to the request relating to selling of the selling item from the terminal device 2 in the selling information table in Step S11. In addition, the control unit 22 generates and transmits the information on the selling item list screen 61 in response to the browsing request or the like from the terminal device 2 or generates and transmits the information on the selling item screen 63 in Step S11.

When it is determined that the request relating to selling of the selling item has not been received (Step S10; No), or when the process of Step S11 has ended, the control unit 22 determines whether or not there is the purchase request on the selling item from the terminal device 2 (Step S12). When it is determined that there is the purchase request on the selling item (Step S12; Yes), the control unit 22 performs the purchase processing with the current price of the selling item corresponding to the purchase request as the transaction price P (Step S13).

When it is determined that there is no purchase request on the selling item (Step S12; No) or when the process of Step S13 has ended, the control unit 22 determines whether or not the selling item is subject to the price change (Step S14). When the price change setting is “yes” in the selling information table, the control unit 22 determines that the selling item is subject to the price change.

When it is determined that the selling item is subject to the price change (Step S14: Yes), the control unit 22 determines whether or not it is the timing for price change (Step S15). For example, when the lowering interval ΔT of the transaction price P comes, the control unit 22 determines that it is the timing for price change. The process of Step S15 is executed by the transaction price changing unit 46.

When it is determined that it is the timing for price change (Step S15; Yes), the control unit 22 performs price change processing (Step S16). The price change processing is processing executed by the above-described transaction price changing unit 46. For example, a process of determining whether or not to change the transaction price P, a process of determining the lowering width ΔP of the transaction price P, a process of updating the transaction price P, and the like are performed.

When it is determined that the selling item is not subject to the price change (Step S14; No), when it is determined that it is not the timing for price change (Step S15; No), or when the process of Step S16 has ended, the control unit 22 determines whether or not there is the registration request from the terminal device 2 (Step S17).

When it is determined that there is the registration request (Step S17; Yes), the control unit 22 performs registration processing in response to the registration request (Step S18). The registration processing is processing executed by the registration processing unit 43. When it is determined that there is no registration request (Step S17; No) or when the process of Step S18 has ended, the control unit 22 performs other processing (Step S19). For example, the control unit 22 can execute processing performed by the notification unit 47 in Step S19.

### 4. Modified Example

Although the example in which the mode of gradually lowering the transaction price P is dynamically changed based on one or more pieces of information among the attention degree Da, the information amount Mc, the time zone and the day of the week, the average transaction price and the average purchase price of the related selling items, and the seller evaluation has been described in the above-described embodiment, the present invention is not limited to the example. For example, the transaction price changing unit 46 can also dynamically change the mode of gradually lowering the transaction price P based on surrounding environment (for example, an occurrence status of a natural disaster, a state of the weather, economic states or conflict states of other countries, and the like) in addition to or instead of these pieces of information.

In addition, the example in which the transaction price changing unit 46 dynamically changes the mode of gradually lowering the transaction price P based on, for example, calculation of the Formulas (1) to (3) and the like has been described in the above-described embodiment, but the invention is not limited to the example. For example, the transaction price changing unit 46 can statistically calculate a mode of lowering the transaction price P of the related product having a purchase record, and dynamically change the mode of gradually lowering the transaction price P based on such a statistical result.

In addition, the example in which the transaction price changing unit 46 dynamically changes the mode of lowering the transaction price P has been described in the above-described embodiment. However, it is possible to lower the transaction price P with the change form selected by the user U without dynamically changing the mode of lowering the transaction price P or not to perform the dynamic change of the mode of lowering the transaction price P.

### 5. Hardware Configuration

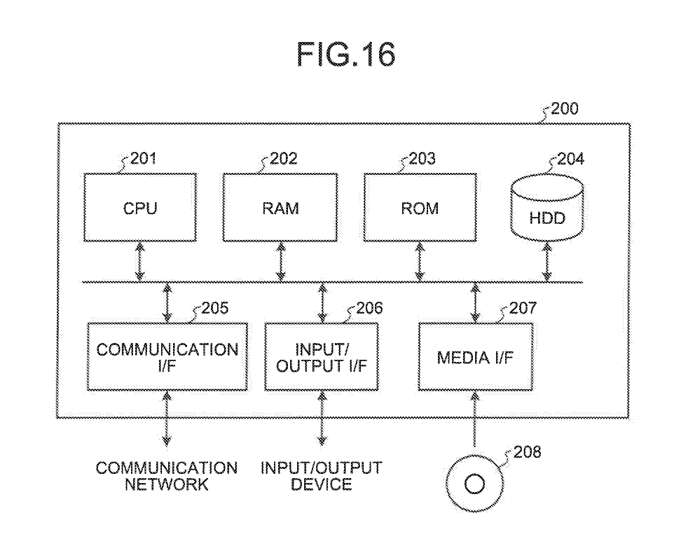

Each of the selling item transaction processing device 1 and the terminal device 2 in the above-described embodiment are implemented, for example, as a computer 200 having a configuration as illustrated in FIG. 16 executes a program.

FIG. 16 is a diagram illustrating an example of a hardware configuration of the computer that executes the program. The computer 200 includes a CPU 201, a RAM 202, a ROM 203, an HDD 204, a communication interface (I/F) 205, an input/output interface (I/F) 206, and a media interface (I/F) 207.

The CPU 201 operates based on a program stored in the ROM 203 or the HDD 204, and controls each unit. The ROM 203 stores a boot program executed by the CPU 201 when the computer 200 is activated, a program dependent on the hardware of the computer 200, and the like.

The HDD 204 stores data used by the program executed by the CPU 201 and the like. The communication interface 205 corresponds to each of the communication units 10 and 20, receives data from another device via the network 3 and sends the data to the CPU 201, and transmits the data generated by the CPU 201 to another device via the network 3.

The CPU 201 controls an output device, such as a display and a printer, and an input device, such as a keyboard and a mouse, via the input/output interface 206. The CPU 201 acquires data from the input device via the input/output interface 206. In addition, the CPU 201 outputs the generated data to the output device via the input/output interface 206.

The media interface 207 reads a program or data stored in a recording medium 208 and provides the read program or data to the CPU 201 via the RAM 202. The CPU 201 loads the program from the recording medium 208 onto the RAM 202 via the media interface 207 and executes the loaded program. The recording medium 208 is, for example, an optical recording medium such as a digital versatile disc (DVD) and a phase change rewritable disk (PD), a magneto-optical recording medium such as a magneto-optical disk (MO), a tape medium, a magnetic recording medium, a semiconductor memory, or the like.

The CPU 201 of the computer 200 implements each function of the above-described control unit (the control unit 11 or the control unit 22) by executing the program loaded on the RAM 202. In addition, some or all of the control units may be configured using only hardware.

The CPU 201 of the computer 200 reads and executes the program from the recording medium 208, but may acquire these programs from another device via the network 3 as another example. Incidentally, the HDD 204 corresponds to each of the storage units 14 and 21, and stores the same data as those of the storage units 14 and 21. In addition, a semiconductor memory element such as a RAM and a flash memory, or a storage device such as an optical disk may be used instead of the HDD 204.

### 6. Effect

The selling item transaction processing device 1 according to the embodiment includes the selling reception unit 41 (the example of the setting reception unit), the transaction price changing unit 46, the purchase reception unit 44, and the purchase processing unit 45 (the example of the processing unit). The selling reception unit 41 receives the setting of the transaction price P of the selling item. The transaction price changing unit 46 gradually lowers the transaction price P. The purchase reception unit 44 receives the purchase request on the selling item at the transaction price P. The purchase processing unit 45 performs the processing in response to the purchase request. The transaction price changing unit 46 dynamically changes the mode of lowering the transaction price P. It is possible to improve the profit that the seller gains and to improve the possibility of purchase of the selling item by dynamically changing the mode of lowering the transaction price P in this manner.

In addition, the transaction price changing unit 46 gradually lowers the transaction price P according to the attention degree Da with respect the selling item. Accordingly, it is possible to prevent the transaction price P from being excessively lowered, to improve the profit that the seller gains, and to enhance the possibility of purchase of the selling item.

In addition, the selling reception unit 41 receives the selling item information, which is published as information on the selling item, as the selling item information reception unit. The transaction price changing unit 46 gradually lowers the transaction price P according to the information amount of the selling item information. Accordingly, it is possible to prevent the transaction price P from being excessively lowered, to improve the profit that the seller gains, and to enhance the possibility of purchase of the selling item.

In addition, when the information amount Mc of the selling item information satisfies the predetermined condition (for example, the condition that the attention degree Da is the set threshold value or more), the transaction price changing unit 46 gradually lowers the transaction price P in the transaction price range higher than the market price of the selling item. Accordingly, it is possible to enhance the possibility of purchase at the appropriate transaction price P.

The information amount Mc of the selling item information includes the number of images of the selling item, and the transaction price changing unit 46 gradually lowers the transaction price P according to the number of images of the selling item. Accordingly, it is possible to decrease the lowering width ΔP of the transaction price P or increase the lowering interval ΔT, for example, as the number of images of the selling item is larger.

In addition, the transaction price changing unit 46 includes the item state determination unit 75 (the example of the determination unit) that determines the state of the selling item based on the selling item information and the price change processing unit 76 that gradually lowers the transaction price P based on the state of the selling item determined by the item state determination unit 75.

Since the possibility of being purchased at a high transaction price is higher as the state of the selling item is better, the transaction price changing unit 46 can enhance the possibility of purchase at the appropriate transaction price P by decreasing the lowering width ΔP of the transaction price P or increasing the lowering interval ΔT as the state of the selling item is better. In addition, since the possibility of being purchased at a low transaction price is higher as the state of the selling item is worse, the transaction price changing unit 46 can enhance the possibility of purchase of the selling item by increasing the lowering width ΔP of the transaction price P or decreasing the lowering interval ΔT as the state of the selling item is worse.

In addition, the transaction price changing unit 46 gradually lowers the transaction price according to at least any one of the time zone and the day of the week. For example, it is possible to boost the intending purchaser to purchase the selling item by decreasing the interval of the change timing in the time zone or the day of the week in which the selling item is likely to be purchased, and accordingly, it is possible to enhance the possibility of purchase of the selling item. For example, it is possible to suppress the change of the transaction price P in the time zone or the day of the week in which the selling item is likely to be purchased by increasing the interval of the change timing of the time zone or the day of the week in which the selling item is likely to be purchased, and accordingly, it is possible to prevent the transaction price P from being excessively lowered and to improve the profit that the seller gains.

In addition, the transaction price changing unit 46 lowers the transaction price P based on the price of another selling item (related selling product) of the same type or similar type with the selling item. Accordingly, it is possible to appropriately set the mode of lowering the transaction price P.

In addition, the selling reception unit 41 receives the setting of the minimum price Pₘᵢₙ with respect to the selling item, and the transaction price changing unit 46 lowers the transaction price P such that the transaction price P does not fall below the minimum price Pin-Accordingly, it is possible to prevent the transaction price P from being excessively lowered, and it is possible to prevent the profit that the seller gains from excessively decreasing while increasing the possibility of purchase of the selling item.

In addition, the selling reception unit 41 receives the setting to cancel the setting of the minimum price Pₘᵢₙ, and the transaction price changing unit 46 lowers the transaction price P regardless of the minimum price Pₘᵢₙ when the setting of the minimum price Pₘᵢₙ is canceled. Accordingly, it is possible to enhance the possibility of purchase of the selling item even when the setting of the set minimum price Pₘᵢₙ is inappropriate.

In addition, the selling reception unit 41 receives the setting of the change form (for example, any one of the first change form to the third change form described above) as the form of gradually lowering the transaction price P. The transaction price changing unit 46 dynamically changes the mode of lowering the transaction price P based on the change form received by the selling reception unit 41. Accordingly, it is possible to dynamically change the mode of lowering the transaction price P with the change form that the user U desires.

In addition, the selling item transaction processing device 1 includes the notification unit 47 that notifies the seller of the selling item of the proposal for the change of the change form based on the attention degree Da with respect to the selling item. Accordingly, it is possible to give the user U an opportunity to increase the possibility of purchase of the selling item.

In addition, the selling reception unit 41 receives the setting to gradually lower the transaction price P using the transaction price changing unit 46. The transaction price changing unit 46 gradually lowers the transaction price P of the selling item when the selling item reception unit 4 receives the setting to gradually lower the transaction price P. Accordingly, the transaction price P of the selling item is gradually lowered by selection of the user U, and thus, it is possible to prevent the transaction price P of the selling item from being gradually lowered without being intended by the user U.

In addition, the selling item transaction processing device 1 includes the notification unit 47 that notifies the seller of the selling item of the proposal for setting to gradually lower the transaction price P based on the attention degree Da with respect to the selling item when the setting to gradually lower the transaction price P is not received by the selling reception unit 41. Accordingly, for example, it is possible to urge the setting to gradually lower the transaction price P with respect to the seller of the selling item with the high attention degree Da or the seller of the selling item with the low attention degree Da, and accordingly, it is possible to enhance the possibility of purchase of the selling item.

The above-described selling item transaction processing device 1 may be implemented by a plurality of server computers, and further, the configuration thereof can be flexibly changed by calling and implementing an external platform or the like using an application programming interface (API), network computing, or the like depending on each function.

In addition, the above-described “unit (section, module, unit)” can be rewritten as a “means” or a “circuit” For example, the processing unit can be rewritten as a processing means or a processing circuit.

According to an aspect of the embodiment, it is possible to provide a selling item transaction processing device capable of appropriately updating a transaction price, a selling item transaction processing method, and a selling item transaction processing program.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A selling item transaction processing device comprising:
a setting reception unit that receives setting of a transaction price of a selling item;
a transaction price changing unit that gradually lowers the transaction price;
a purchase reception unit that receives a purchase request on the selling item at the transaction price; and
a processing unit that performs processing in response to the purchase request,
wherein the transaction price changing unit dynamically changes a mode of lowering the transaction price.

2. The selling item transaction processing device according to claim 1, wherein
the transaction price changing unit gradually decreases the transaction price according to a degree of attention with respect to the selling item.

3. The selling item transaction processing device according to claim 1, further comprising:
a selling item information reception unit that receives selling item information which is published as information on the selling item,
wherein the transaction price changing unit gradually lowers the transaction price according to an information amount of the selling item information.

4. The selling item transaction processing device according to claim 3, wherein
the transaction price changing unit gradually lowers the transaction price in a transaction price range higher than a market price of the selling item when the information amount of the selling item information satisfies a predetermined condition.

5. The selling item transaction processing device according to claim 3, wherein
the information amount of the selling item information includes the number of images of the selling item, and
the transaction price changing unit gradually decreases the transaction price according to the number of images of the selling item.

6. The selling item transaction processing device according to claim 3, wherein
the transaction price changing unit includes:
a determination unit that determines a state of the selling item based on the selling item information; and
a price change processing unit that gradually lowers the transaction price based on the state of the selling item determined by the determination unit.

7. The selling item transaction processing device according to claim 1, wherein
the transaction price changing unit gradually lowers the transaction price according to at least one of a time zone and a day of a week.

8. The selling item transaction processing device according to claim 1, wherein
the transaction price changing unit lowers the transaction price based on prices of other selling items of a same type or a similar type with the selling item.

9. The selling item transaction processing device according to claim 1, wherein
the setting reception unit receives setting of a minimum price with respect to the selling item, and
the transaction price changing unit lowers the transaction price such that the transaction price does not fall below the minimum price.

10. The selling item transaction processing device according to claim 9, wherein
the setting reception unit receives setting to cancel the setting of the minimum price, and
the transaction price changing unit lowers the transaction price regardless of the minimum price when the setting of the minimum price is canceled.

11. The selling item transaction processing device according to claim 1, wherein
the setting reception unit receives setting of a form to gradually lower the transaction price, and
the transaction price changing unit dynamically changes a mode of lowering the transaction price based on the form received by the setting reception unit.

12. The selling item transaction processing device according to claim 11, further comprising:
a notification unit that notifies a seller of the selling item of a proposal for a change of the form based on a degree of attention with respect to the selling item.

13. The selling item transaction processing device according to claim 1, wherein
the setting reception unit receives setting to gradually lower the transaction price using the transaction price changing unit, and
the transaction price changing unit gradually lowers the transaction price of the selling item when the setting to gradually lower the transaction price is received by the setting reception unit.

14. The selling item transaction processing device according to claim 13, further comprising:
a notification unit that notifies a seller of the selling item of a proposal for the setting to gradually lower the transaction price based on a degree of attention with respect to the selling item when the setting to gradually lower the transaction price is not received by the setting reception unit.

15. A selling item transaction processing method executed by a computer, the method comprising:
a setting reception step of receiving setting of a transaction price of a selling item;
a transaction price changing step of dynamically changing a mode of gradually lowering the transaction price;
a purchase reception step of receiving a purchase request on the selling item at the transaction price; and
a processing step of performing processing in response to the purchase request.

16. A non-transitory computer readable storage medium having stored therein a selling item transaction processing program causing a computer to execute a process comprising:
a setting reception procedure of receiving setting of a transaction price of a selling item;
a transaction price changing procedure of dynamically changing a mode of gradually lowering the transaction price;
a purchase reception procedure of receiving a purchase request on the selling item at the transaction price; and
a processing procedure of performing processing in response to the purchase request.
